(19) United States
(12) Patent Application Publication
(10) Pub. No.: US 2024/0255705 A1
(43) Pub. Date: Aug. 1, 2024

(54) METHOD FOR MANUFACTURING OPTICAL FIBER BUNDLE, OPTICAL FIBER BUNDLE, OPTICAL CONNECTION STRUCTURE, AND DETERMINATION METHOD

(71) Applicant: SUMITOMO ELECTRIC INDUSTRIES, LTD., Osaka-shi (JP)

(72) Inventor: Takahiro KIKUCHI, Osaka-shi (JP)

(73) Assignee: SUMITOMO ELECTRIC INDUSTRIES, LTD., Osaka-shi (JP)

(21) Appl. No.: 18/421,045

(22) Filed: Jan. 24, 2024

(30) Foreign Application Priority Data
Jan. 27, 2023 (JP) 2023-011086

(51) Int. Cl. G02B 6/38; G01M 11/00

(52) U.S. Cl. CPC G02B 6/3861; G01M 11/30; G02B 6/3851

(57) ABSTRACT

A method for manufacturing an optical fiber bundle comprising preparing a ferrule, preparing a holding portion, preparing a plurality of optical fibers, inserting a first diameter portion of each of the plurality of optical fibers into a first portion of a first fiber accommodating hole, confirming an arrangement of the plurality of optical fibers at a front end of the ferrule, determining whether one or both of crossing and deviation occur, and fixing the plurality of optical fibers to the ferrule with an adhesive. In the preparing the plurality of optical fibers, the coating of each of the plurality of optical fibers includes a different appearance for each optical fiber. In a case where one or both of the crossing and the deviation occur in the determining, the inserting, the confirming and the determining are performed again before the fixing.

### CROSS REFERENCE

The present application claims priority based on Japanese Patent Application No. 2023-011086 filed on Jan. 27, 2023, the entire contents of which are incorporated herein by reference.

### TECHNICAL FIELD

The present disclosure relates to a method for manufacturing an optical fiber bundle, an optical fiber bundle, an optical connection structure, and a determination method.

### BACKGROUND

Patent Literature 1 (Japanese Unexamined Patent Publication No. 2017-167299) and Patent Literature 2 (Japanese Unexamined Patent Publication No. 2013-68891) disclose an optical fiber bundle in which a plurality of optical fibers are inserted into a ferrule. In the optical fiber bundle described in Patent Literature 1, the plurality of optical fibers are twisted inside the ferrule (capillary) to be aligned in a close packed structure. In the optical fiber bundle described in Patent Literature 2, the optical fibers subjected to diameter reduction process by etching are housed in the ferrule.

### SUMMARY

A method for manufacturing an optical fiber bundle according to an aspect of the present disclosure is a method for manufacturing an optical fiber bundle for optically coupling a plurality of optical fibers to a multicore optical fiber. The method comprising preparing a ferrule, preparing a holding portion, preparing a plurality of optical fibers, inserting, confirming, determining, and fixing. In the preparing the ferrule, the ferrule extends along a first direction. The ferrule has a front end in the first direction, a rear end opposite to the front end in the first direction, and a first fiber accommodating hole. The first fiber accommodating hole is a hole including a first portion that is located at the front end, a second portion that is located at the rear end and has a larger inner diameter than an inner diameter of the first portion, and an inner diameter transition portion that connects the first portion and the second portion to each other. In the preparing the holding portion, the holding portion has a second fiber accommodating hole as a hole extending along the first direction and communicating with the first fiber accommodating hole at the rear end of the ferrule. In the preparing the plurality of optical fibers, each of the plurality of optical fibers has a glass fiber and a coating portion. The glass fiber includes a first diameter portion, a second diameter portion having a larger diameter than a diameter of the first diameter portion, a tapered portion connecting the first diameter portion and the second diameter portion, a tip surface located at a tip end of the first diameter portion, and a terminal end surface opposite to the tip surface. At least the first diameter portion, the tapered portion, and the second diameter portion extend along the first direction. The coating portion is formed by covering a glass fiber continuous with the second diameter portion with a coating. In the inserting, the first diameter portion of each of the plurality of optical fibers is inserted into the first portion of the first fiber accommodating hole. The tapered portion of each of the plurality of optical fibers is inserted into the second portion of the first fiber accommodating hole. A boundary between the second diameter portion of each of the plurality of optical fibers and the coating portion of each of the plurality of optical fibers is inserted into the second fiber accommodating hole. In the confirming, an arrangement of the plurality of optical fibers at the front end of the ferrule is confirmed by conducting light from the terminal end surface of each of the plurality of optical fibers and observing the tip surface of each of the plurality of optical fibers. In the determining, it is determined whether one or both of crossing and deviation occur. The crossing is a crossing within the ferrule between the first diameter portion of one optical fiber among the plurality of optical fibers and the first diameter portion of an other optical fiber among the plurality of optical fibers. The deviation is a deviation between an arrangement of the plurality of optical fibers at the front end of the ferrule and an arrangement of the plurality of optical fibers at the second fiber accommodating hole. The deviation is a deviation of a predetermined angle or more along a circumferential direction around a central axis of the first fiber accommodating hole and the second fiber accommodating hole. In the fixing, the plurality of optical fibers are fixed to the ferrule with an adhesive. In the preparing the plurality of optical fibers, the coating of each of the plurality of optical fibers includes a different appearance for each optical fiber and is fixed to the coating of at least one optical fiber among other optical fibers. In a case where one or both of the crossing and the deviation occur in the determining, the inserting, the confirming and the determining are performed again before the fixing.

### BRIEF DESCRIPTION OF THE DRAWINGS

FIG. 1 is a perspective view illustrating an optical connection structure according to an embodiment;

FIG. 2 is an exploded perspective view of the optical connection structure illustrated in FIG. 1;

FIG. 3 is a cross-sectional view of the optical connection structure illustrated in FIG. 1 along the line III-III;

FIG. 4 is a view illustrating a tip of a multicore fiber and an end surface of a ferrule;

FIG. 5 is a view illustrating tips of a plurality of optical fibers and an end surface of the ferrule;

FIG. 6 is a schematic view illustrating an optical fiber;

FIG. 7 is a perspective view illustrating the plurality of optical fibers extending to the outside of the flange;

FIG. 8 is a perspective view of the plurality of optical fibers;

FIG. 9 is a schematic cross-sectional view illustrating an inner hole of the ferrule;

FIG. 10 is a schematic cross-sectional view illustrating the plurality of optical fibers inserted into the inner hole of the ferrule and an inner hole of the flange;

FIG. 11 is a perspective view illustrating a form of the plurality of optical fibers in the inner hole of the ferrule and the inner hole of the flange;

FIG. 12 is a flowchart illustrating a method for manufacturing an optical fiber bundle;

FIG. 13 is a schematic view illustrating the plurality of optical fibers inserted into the inner hole of the ferrule and an inner hole of the flange;

FIG. 14 is a schematic front view illustrating an example of an arrangement of the plurality of optical fibers in the inner hole of the flange;

FIG. 15 is a schematic perspective view illustrating an example of an arrangement of the plurality of optical fibers at a front end of the ferrule;

FIG. 16 is a schematic perspective view illustrating an example of an arrangement of the plurality of optical fibers at the front end of the ferrule;

FIG. 17 is a schematic perspective view illustrating an example of an arrangement of the plurality of optical fibers at the front end of the ferrule; and

FIG. 18 is a view illustrating a fan-in/fan-out device including the optical connection structure illustrated in FIG. 1.

### DETAILED DESCRIPTION

### Problems to be Solved by Invention

In the optical fiber bundle described in Patent Literature 1 and Patent Literature 2, there is a possibility that bending loss in a plurality of optical fibers increases inside a ferrule. Specifically, in manufacturing an optical fiber bundle, when a plurality of optical fibers are inserted from the rear end of the ferrule, crossing or twisting of the plurality of optical fibers may occur. In this case, there is a risk of increased bending in the plurality of optical fibers inside the ferrule, and increased bending loss in the plurality of optical fibers.

According to the present disclosure, it is possible to provide a method of manufacturing an optical fiber bundle, an optical fiber bundle, an optical connection structure, and a determination method capable of reducing the bending loss in the plurality of optical fibers.

### DESCRIPTION OF EMBODIMENTS OF PRESENT DISCLOSURE]

First, contents of embodiments of the present disclosure will be listed and described.

[1] A method of manufacturing an optical fiber bundle according to an aspect of the present disclosure is a method for manufacturing an optical fiber bundle for optically coupling a plurality of optical fibers to a multicore optical fiber. The method comprising preparing a ferrule, preparing a holding portion, preparing a plurality of optical fibers, inserting, confirming, determining, and fixing. In the preparing the ferrule, the ferrule extends along a first direction. The ferrule has a front end in the first direction, a rear end opposite to the front end in the first direction, and a first fiber accommodating hole. The first fiber accommodating hole is a hole including a first portion that is located at the front end, a second portion that is located at the rear end and has a larger inner diameter than an inner diameter of the first portion, and an inner diameter transition portion that connects the first portion and the second portion to each other. In the preparing the holding portion, the holding portion has a second fiber accommodating hole as a hole extending along the first direction and communicating with the first fiber accommodating hole at the rear end of the ferrule. In the preparing the plurality of optical fibers, each of the plurality of optical fibers has a glass fiber and a coating portion. The glass fiber includes a first diameter portion, a second diameter portion having a larger diameter than a diameter of the first diameter portion, a tapered portion connecting the first diameter portion and the second diameter portion, a tip surface located at a tip end of the first diameter portion, and a terminal end surface opposite to the tip surface. At least the first diameter portion, the tapered portion, and the second diameter portion extend along the first direction. The coating portion is formed by covering a glass fiber continuous with the second diameter portion with a coating. In the inserting, the first diameter portion of each of the plurality of optical fibers is inserted into the first portion of the first fiber accommodating hole. The tapered portion of each of the plurality of optical fibers is inserted into the second portion of the first fiber accommodating hole. A boundary between the second diameter portion of each of the plurality of optical fibers and the coating portion of each of the plurality of optical fibers is inserted into the second fiber accommodating hole. In the confirming, an arrangement of the plurality of optical fibers at the front end of the ferrule is confirmed by conducting light from the terminal end surface of each of the plurality of optical fibers and observing the tip surface of each of the plurality of optical fibers. In the determining, it is determined whether one or both of crossing and deviation occur. The crossing is a crossing within the ferrule between the first diameter portion of one optical fiber among the plurality of optical fibers and the first diameter portion of an other optical fiber among the plurality of optical fibers. The deviation is a deviation between an arrangement of the plurality of optical fibers at the front end of the ferrule and an arrangement of the plurality of optical fibers at the second fiber accommodating hole. The deviation is a deviation of a predetermined angle or more along a circumferential direction around a central axis of the first fiber accommodating hole and the second fiber accommodating hole. In the fixing, the plurality of optical fibers are fixed to the ferrule with an adhesive. In the preparing the plurality of optical fibers, the coating of each of the plurality of optical fibers includes a different appearance for each optical fiber and is fixed to the coating of at least one optical fiber among other optical fibers. In a case where one or both of the crossing and the deviation occur in the determining, the inserting, the confirming and the determining are performed again before the fixing.

In this method for manufacturing an optical fiber bundle, in a case where one or both of the crossing and the deviation occur in the determining, the inserting, the confirming, and the determining are performed again before the fixing. According to this configuration, it is possible to manufacture an optical fiber bundle in which one or both of crossing and twisting of the plurality of optical fibers inside the ferrule is suppressed. As a result, it is possible to manufacture an optical fiber bundle in which the bending loss of the plurality of optical fibers is reduced. Each of the coatings of the plurality of optical fibers includes a different appearance for each optical fiber. According to this configuration, the coating portions of the plurality of optical fibers can be easily distinguished based on the appearances of the coatings.

Accordingly, it is possible to confirm the correspondence between the coating portions of the plurality of optical fibers at the rear end of the ferrule and the terminal end surfaces of the plurality of optical fibers. Here, by conducting light from the terminal end surfaces of the plurality of optical fibers and confirming the correspondence between the terminal end surfaces and the tip surfaces of the plurality of optical fibers, it is possible to confirm the correspondence between the coating portions of the plurality of optical fibers at the rear end of the ferrule and the tip surfaces of the plurality of optical fibers at the front end of the ferrule. Therefore, it is possible to compare the arrangement of the plurality of optical fibers at the rear end of the ferrule with the arrangement of the plurality of optical fibers at the front end of the ferrule. As a result, in the determining, it is possible to easily determine whether one or both of the crossing and the deviation occur.

[2] In the method of manufacturing an optical fiber bundle of [1], the preparing the plurality of optical fibers may include changing an appearance of the coating. In this case, the appearance of the coating can be easily distinguished.

[3] In the method of manufacturing an optical fiber bundle of [2], in the changing, the appearance of the coating may be changed by laser irradiation. In this case, the appearance of the coating can be easily changed.

[4] In the method of manufacturing an optical fiber bundle of [2], in the changing, the appearance of the coating may be changed by coloring. In this case, the appearance of the coating can be easily changed.

[5] In the method of manufacturing an optical fiber bundle of [2], in the changing, the appearance of the coating may be changed by labeling with a tape. In this case, the appearance of the coating can be easily changed.

[6] An optical fiber bundle according to an aspect of the present disclosure is an optical fiber bundle for optically coupling a plurality of optical fibers to a multicore optical fiber. The optical fiber bundle comprises a ferrule, a holding portion, and a plurality of optical fibers. The ferrule extends along a first direction. The ferrule has a front end in the first direction, a rear end opposite to the front end in the first direction, and a first fiber accommodating hole. The first fiber accommodating hole is a hole including a first portion that is located at the front end, a second portion that is located at the rear end and has a larger inner diameter than an inner diameter of the first portion, and an inner diameter transition portion that connects the first portion and the second portion to each other.

The holding portion has a second fiber accommodating hole that is a hole extending along the first direction and communicates with the first fiber accommodating hole at the rear end of the ferrule. Each of the plurality of optical fibers has a glass fiber and a coating portion. The glass fiber includes a first diameter portion, a second diameter portion having a larger diameter than a diameter of the first diameter portion, and a tapered portion connecting the first diameter portion and the second diameter portion. At least the first diameter portion, the tapered portion, and the second diameter portion extend along the first direction. The coating portion is formed by covering a glass fiber continuous with the second diameter portion with a coating. The first diameter portion of each of the plurality of optical fibers is inserted into the first portion of the first fiber accommodating hole. The tapered portion of each of the plurality of optical fibers is inserted into the second portion of the first fiber accommodating hole. A boundary between the second diameter portion of each of the plurality of optical fibers and the coating portion of each of the plurality of optical fibers is inserted into the second fiber accommodating hole. The plurality of optical fibers are fixed to the ferrule with an adhesive. The coating of each of the plurality of optical fibers includes a different appearance for each optical fiber and is fixed to the coating of at least one optical fiber of the plurality of optical fibers. The coating of each of the plurality of optical fibers includes a tip portion adjacent to the second diameter portion and a terminal end portion opposite to the tip portion. The optical fiber bundle has at least one configuration of a first configuration and a second configuration. The first configuration is a configuration in which the first diameter portion of one optical fiber of the plurality of optical fibers has no crossing with first diameter portions within the ferrule, each of the first diameter portions being the first diameter portion of an other optical fiber of the plurality of optical fibers. The second configuration is a configuration in which an arrangement of the plurality of optical fibers at the front end of the ferrule has no deviation with an arrangement of the plurality of optical fibers at the second fiber accommodating hole along a circumferential direction around a central axis of the first fiber accommodating hole and the second fiber accommodating hole, or has the deviation of less than 90 degrees.

The optical fiber bundle has at least one configuration of a first configuration and a second configuration. The first configuration is a configuration in which the first diameter portion of one optical fiber of the plurality of optical fibers has no crossing with first diameter portions within the ferrule, each of the first diameter portions being the first diameter portion of an other optical fiber of the plurality of optical fibers.

The second configuration is a configuration in which an arrangement of the plurality of optical fibers at the front end of the ferrule has no deviation with an arrangement of the plurality of optical fibers at the second fiber accommodating hole along a circumferential direction around a central axis of the first fiber accommodating hole and the second fiber accommodating hole, or has the deviation of less than 90 degrees. According to such a configuration, one or both of crossing and twisting of the plurality of optical fibers within the ferrule is suppressed.

As a result, the bending loss of the plurality of optical fibers can be reduced. The coating of each of the plurality of optical fibers includes a different appearance for each optical fiber. According to this configuration, the plurality of optical fibers can be easily distinguished.

[7] In the optical fiber bundle of [6], in each of the plurality of optical fibers, an appearance of the tip portion of the coating and an appearance of the terminal end portion of the coating may include colors or hues corresponding to each other. In this case, a plurality of optical fibers can be easily distinguished at the tip portion and the terminal end portion of the coating.

[8] In the optical fiber bundle of [6] or [7], an appearance of the coating of each of the plurality of optical fibers may include a different color or hue for each optical fiber. In this case, the plurality of optical fibers can be easily distinguished.

[9] In the optical fiber bundle of any one of [6] to [8], an appearance of the coating of each of the plurality of optical fibers may include a different marking for each optical fiber. In this case, the plurality of optical fibers can be easily distinguished.

[10] In the optical fiber bundle of any one of [6] to [9], the coating of each of the plurality of optical fibers may have a different outer diameter for each optical fiber. In this case, the plurality of optical fibers can be easily distinguished.

[11] In the optical fiber bundle of any one of [6] to [10], the coating of each of the plurality of optical fibers may include a different material for each optical fiber. In this case, the plurality of optical fibers can be easily distinguished.

[12] In the optical fiber bundle of any one of [6] to [11], each of the plurality of optical fibers may include a first tape and a second tape having appearances corresponding to each other. The appearances of the first tapes of the plurality of optical fibers may be different from each other. The appearances of second tapes of the plurality of optical fibers may be different from each other. The tip portion of the coating may be labeled with the first tape. The terminal end portion of the coating may be labeled with the second tape. In this case, the appearance of the coating can be easily changed.

[13] In the optical fiber bundle of any one of [6] to [12], at least a part of the plurality of optical fibers may be formed into an optical fiber ribbon. In this case, deviation of the coating portions along the first direction can be suppressed, and an increase in bending of the plurality of optical fibers in the second fiber accommodating hole can be suppressed. This makes it possible to reduce the bending loss of the plurality of optical fibers.

[14] An optical connection structure according to an aspect of the present disclosure may include: an optical connector including the optical fiber bundle of any one of [6] to [13]; and another optical connector including a multi-core optical fiber and another ferrule, the multi-core optical fiber including a plurality of cores extending along a first direction and a cladding covering the plurality of cores, and the another ferrule holding a tip of the multi-core optical fiber. When the optical connector is connected to the another optical connector, each core of the plurality of optical fibers may be optically coupled to the plurality of cores of the multi-core optical fiber. In this optical connection structure, it is possible to reduce bending loss in the plurality of optical fibers.

[15] A determination method according to an aspect of the present disclosure is a method for determining a state of a plurality of optical fibers in a ferrule when the plurality of optical fibers are inserted into a hole provided in the ferrule from a rear end of the ferrule. The determination method comprises confirming and determining. In the confirming, an arrangement of the plurality of optical fibers at a front end of the ferrule is confirmed by conducting light from a terminal end surface of each of the plurality of optical fibers and observing a tip surface of each of the plurality of optical fibers, the tip surface being opposite to the terminal end surface. In the determining, it is determined whether one or both of crossing and deviation occur. In the determining, the crossing is a crossing within the ferrule between one optical fiber of the plurality of optical fibers and other optical fibers of the plurality of optical fibers. In the determining, the deviation is a deviation between an arrangement of the plurality of optical fibers at a front end of the ferrule and an arrangement of the plurality of optical fibers at a rear end of the ferrule. In the determining, the deviation is a deviation of a predetermined angle or more along a circumferential direction around a central axis of the hole of the ferrule.

In this determination method, it is determined whether one or both of the crossing within the ferrule between one optical fiber and another optical fiber among the plurality of optical fibers and a deviation between the arrangement of the plurality of optical fibers at the front end of the ferrule and the arrangement of the plurality of optical fibers at the rear end of the ferrule, which is a deviation of a predetermined angle or more along the circumferential direction around the central axis of the hole of the ferrule, occur. According to this configuration, one or both of crossing and twisting of the plurality of optical fibers are suppressed inside the ferrule. Accordingly, in the optical fiber bundle, it is possible to reduce bending loss in the plurality of optical fibers.

### Details of Embodiments of Present Disclosure]

Specific examples of a method for manufacturing an optical fiber bundle, an optical fiber bundle, an optical connection structure, and a determination method according to the present embodiment will be described with reference to the drawings as necessary. It should be noted that the present invention is not limited to these examples, is described by the claims, and is intended to include meanings equivalent to the claims and all changes within the scope of the claims. In the following description, the same elements are denoted by the same reference numerals in the description of the drawings, and redundant description will be omitted.

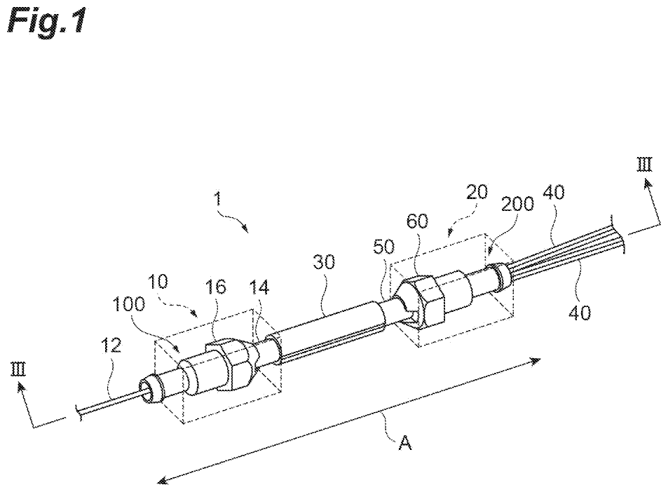

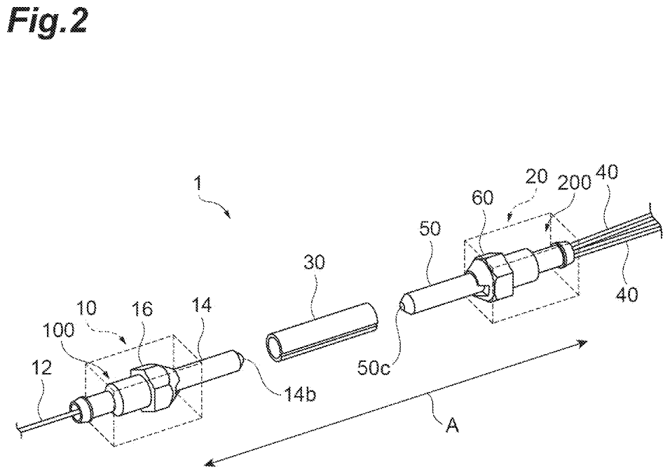

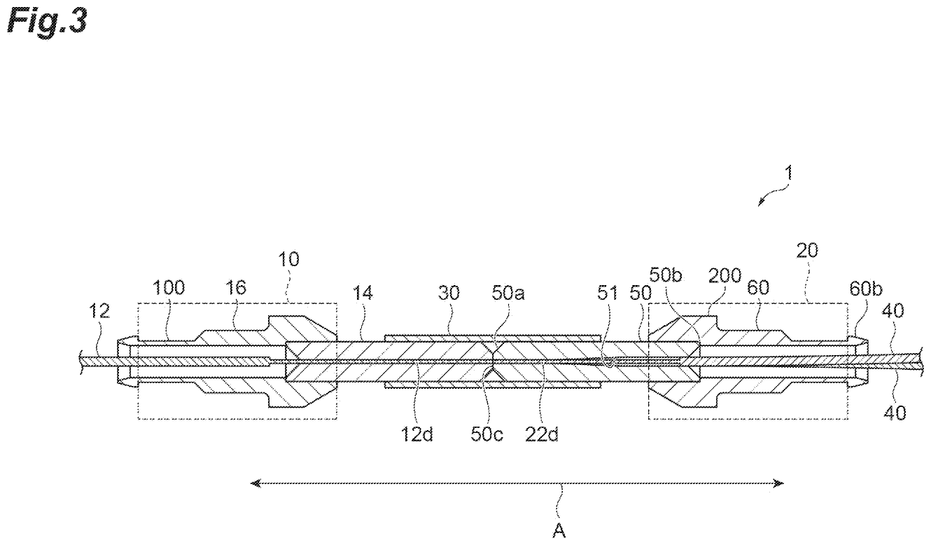

FIG. 1 is a perspective view illustrating an optical connection structure according to an embodiment. FIG. 2 is an exploded perspective view of the optical connection structure illustrated in FIG. 1. FIG. 3 is a cross-sectional view of the optical connection structure illustrated in FIG. 1 along the line III-III. As illustrated in FIGS. 1 to 3, an optical connection structure 1 includes a first optical connector 10, a second optical connector 20, and a split sleeve 30 (sleeve).

The first optical connector 10 includes a structure 100 having a multicore fiber 12 (hereinafter, also referred to as “MCF 12”), a ferrule 14, and a flange 16. The second optical connector 20 includes an optical fiber bundle 200 having a plurality of optical fibers 40, a ferrule 50, and a flange 60 (holding portion). The optical fiber bundle 200 is configured to optically couple the plurality of optical fibers 40 to the MCF 12. When the first optical connector 10 is connected to the second optical connector 20, each core of the plurality of optical fibers 40 is optically coupled to each of the plurality of cores of the MCF 12. The split sleeve 30 is a member that holds the ferrule 14 and the ferrule 50 from the outside so that a central axis of the ferrule 14 of the first optical connector 10 coincides with a central axis of the ferrule 50.

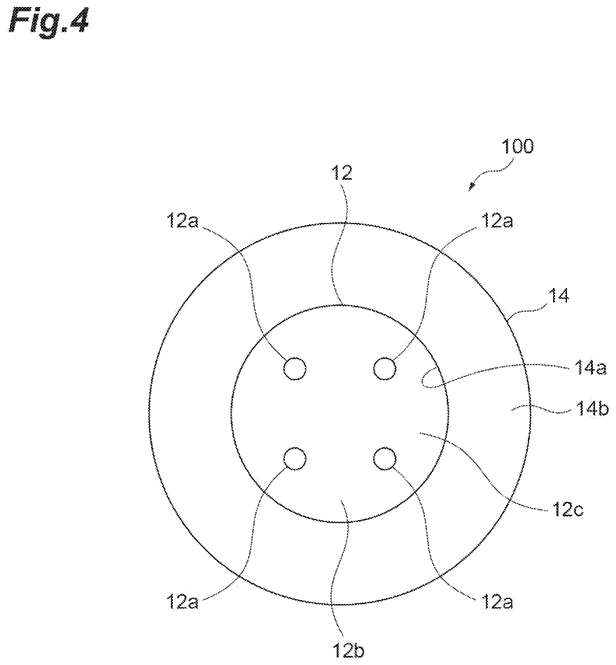

FIG. 4 is a view schematically illustrating a tip of the MCF 12 and an end surface of the ferrule 14. As illustrated in FIG. 4, the MCF 12 has a plurality of cores 12a, a cladding 12b, and a tip surface 12c. The plurality of cores 12a extend along a longitudinal direction A (see FIGS. 1 to 3). The cladding 12b extends along the longitudinal direction A and the tip surface 12c collectively covering the plurality of cores 12a is configured by tips of the plurality of cores 12a and a tip of the cladding 12b. The core 12a mainly contains silica glass doped with a dopant such as germanium to increase a refractive index. The cladding 12b mainly contains silica glass doped with a dopant such as fluorine to lower a refractive index. The composition of the core 12a and the cladding 12b and the combination of dopants can be appropriately selected. In such an MCF 12, each core 12a can propagate an optical signal for each core 12a.

In a cross-section perpendicular to the central axis of the MCF 12, the plurality of cores 12a are, for example, two-dimensionally arranged. In the present embodiment, the MCF 12 has four cores 12a. The MCF 12 may have seven cores 12a. The MCF 12 may have eight cores 12a. The MCF 12 may have nineteen cores 12a. The number of cores 12a of the MCF 12 is not limited thereto. In an example illustrated in FIG. 4, four cores 12a are arranged in a square lattice pattern of 2 rows and 2 columns. The diameter (core diameter) of each core 12a may be, for example, 10 μm or less, or 5 μm or less. The diameter (core diameter) of each core 12a may be, for example, 1 μm or more. The core pitch (distance between centers) between the adjacent cores 12a may be, for example, 10 μm or more and 50 μm or less. The diameter (cladding diameter) of the cladding 12b may be, for example, 200 μm or less, 125 μm or less, 100 μm or less, or 80 μm or less. The diameter (cladding diameter) of the cladding 12b may be 50 μm or more.

The ferrule 14 is a cylindrical member holding a tip portion 12d (see FIG. 3) of the MCF 12. The ferrule 14 has an inner hole 14a and an end surface 14b. The inner hole 14a is a through hole accommodating the tip portion 12d of the MCF 12. The ferrule 14 fixes the tip portion 12d of the MCF 12 to the inner hole 14a such that the tip surface 12c of the MCF 12 is exposed at the end surface 14b. The inner diameter of the inner hole 14a is the same as or slightly larger than the outer diameter of the MCF 12, and the tip portion 12d of the MCF 12 is fitted into the inner hole 14a by being inserted into the inner hole 14a. The ferrule 14 has a length of, for example, 6 mm or more and 8 mm or less. The ferrule 14 is made of, for example, a ceramic material such as zirconia.

As illustrated in FIG. 3, the flange 16 holds a rear end portion of the ferrule 14. The flange 16 is a tubular member accommodating the MCF 12 thereinside. A portion of the MCF 12 accommodated in the flange 16 may be fixed inside the flange 16 by an adhesive. The flange 16 is made of, for example, a metal or a resin.

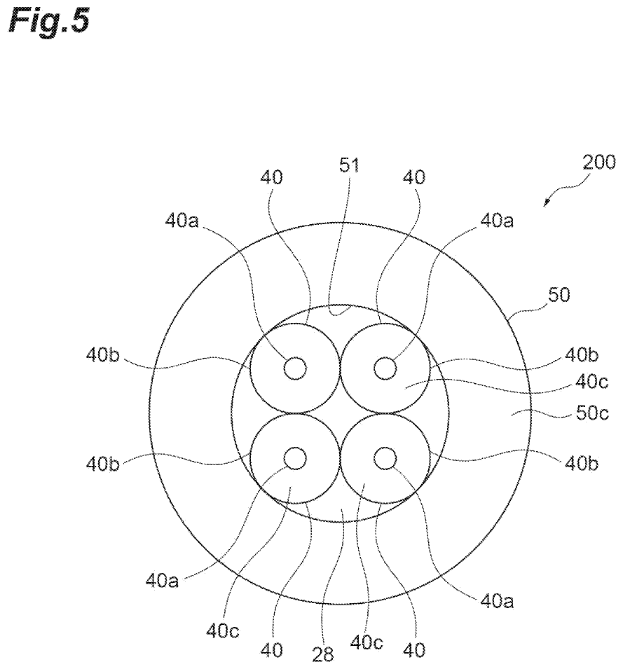

The plurality of optical fibers 40 are optical fibers optically coupled to the MCF 12. FIG. 5 is a view illustrating the tips of the plurality of optical fibers 40 and an end surface of the ferrule 50. As illustrated in FIG. 5, each optical fiber 40 has a core 40a and a cladding 40b. The core 40a extends in the longitudinal direction A (see FIGS. 1 to 3). The cladding 40b extends in the longitudinal direction A and covers the core 40a. Each optical fiber 40 has a tip surface 40c. The tip surface 40c is configured by a tip of the core 40a and a tip of the cladding 40b. The core 40a mainly contains silica glass doped with a dopant such as germanium to increase a refractive index. The cladding 40b mainly contains silica glass doped with a dopant such as fluorine to lower a refractive index. The composition of the core 40a and the cladding 40b and the combination of dopants can be appropriately selected. In such an optical fiber 40, each core 40a propagates an optical signal.

The optical fiber 40 is, for example, a single mode fiber. In this case, a refractive index distribution in a radial direction of the optical fiber 40 is a trench type. As a result, the optical loss when the optical fiber 40 is bent can be reduced as compared with a case where the refractive index distribution is a monomodal type. The optical loss when light having a wavelength of 1.55 μm passes through the optical fiber 40 may be 0.15 dB or less. The optical loss when light having a wavelength of 1.625 μm passes through the optical fiber 40 may be 0.45 dB or less. The refractive index distribution in the radial direction of the optical fiber 40 may be a monomodal type.

The plurality of optical fibers 40 are two-dimensionally arranged in a cross-section orthogonal to the longitudinal direction A. In an example illustrated in FIG. 5, four optical fibers 40 are arranged in a square lattice pattern of 2 rows and 2 columns. In the present embodiment, the second optical connector 20 has four optical fibers 40. The second optical connector 20 may have seven optical fibers 40, eight optical fibers 40, or nineteen optical fibers 40. The number of optical fibers of the second optical connector 20 is not limited to the above. The number and arrangement of the plurality of optical fibers 40 of the second optical connector 20 correspond to the number and arrangement of the plurality of cores 12a of the MCF 12 of the first optical connector 10 on a one-to-one basis. In other words, the arrangement of the plurality of optical fibers 40 coincides with the arrangement of the plurality of cores 12a of the MCF 12. However, the number and arrangement of the plurality of optical fibers 40 do not need to completely coincide with the number and arrangement of the plurality of cores 12a of the MCF 12. For example, at least one of the plurality of optical fibers 40 may be configured not to be optically connected to the core 12a. Alternatively, at least one of the plurality of cores 12a may be configured not to be optically connected to the optical fiber 40. The plurality of optical fibers 40 are optically coupled to each core 12a of the MCF 12 of the first optical connector 10 by rotational adjustment around a central axis of the ferrule 50.

The diameter (core diameter) of each core 40a may be, for example, 10 μm or less or 5 μm or less. The diameter (core diameter) of each core 40a may be, for example, 1 μm or more. The core pitch (distance between centers) between the adjacent cores 40a may be, for example, 10 μm or more and 50 μm or less. The diameter (cladding diameter) of the cladding 40b may be 80 μm or more and 125 μm or less outside the ferrule 50 described below. The diameter of the cladding 40b is smaller inside the ferrule 50 than outside the ferrule 50. The circumscribed circle of the bundle of a plurality of claddings 40b reduced in diameter coincides with the cladding diameter of the MCF 12.

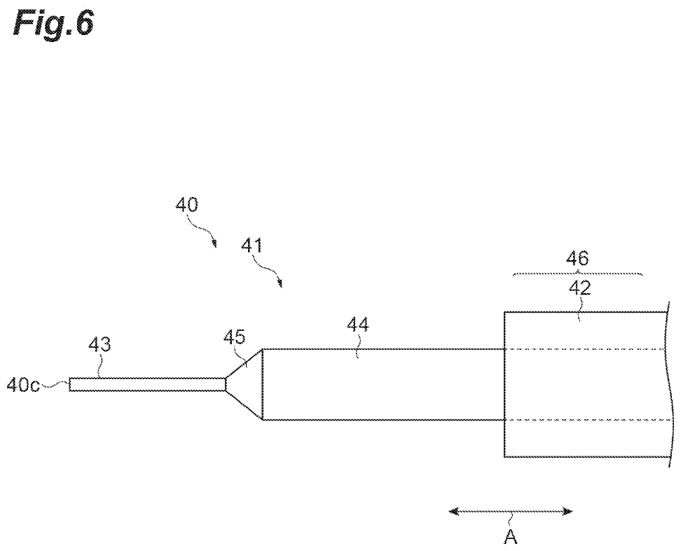

The outer diameter of the cladding 40b is narrower inside the ferrule 50 than the outer diameter outside the ferrule 50. Such an optical fiber can be realized by etching the tip portion with hydrofluoric acid liquid or the like. FIG. 6 is a schematic view illustrating the optical fiber 40 viewed from a direction intersecting the longitudinal direction A. Each optical fiber 40 has a glass fiber 41 made of glass and a coating 42 made of a resin. The glass fiber 41 includes a first diameter portion 43, a second diameter portion 44, and a tapered portion 45. The tapered portion 45 connects the first diameter portion 43 and the second diameter portion 44 to each other. A portion of the glass fiber 41 continuous with the second diameter portion 44 is covered with the coating 42 while being covered therearound. The portion of the glass fiber 41 continuous with the second diameter portion 44 and the coating 42 constitute a coating portion 46. An organic resin material is usually used for the coating 42. For example, an ultraviolet curable resin or a thermosetting resin is used for the coating 42.

The first diameter portion 43 includes the tip surface 40c. The first diameter portion 43 extends from the tip surface 40c along the longitudinal direction A. The diameter of the first diameter portion 43 is, for example, 40 μm. The tapered portion 45 is continuous with the first diameter portion 43 and extends along the longitudinal direction A. The length of the tapered portion 45 in the longitudinal direction A is, for example, 0.1 mm or more and 0.5 mm or less. The diameter of the tapered portion 45 increases from the first diameter portion 43 toward the second diameter portion 44. The second diameter portion 44 is continuous with the tapered portion 45 and extends along the longitudinal direction A. In other words, the tapered portion 45 is located between the first diameter portion 43 and the second diameter portion 44 in the longitudinal direction A. The second diameter portion 44 has a diameter larger than that of the first diameter portion 43. The diameter of the second diameter portion 44 is, for example, 80 μm or more and 125 μm or less. The coating 42 covers the periphery of the glass fiber 41 in the coating portion 46.

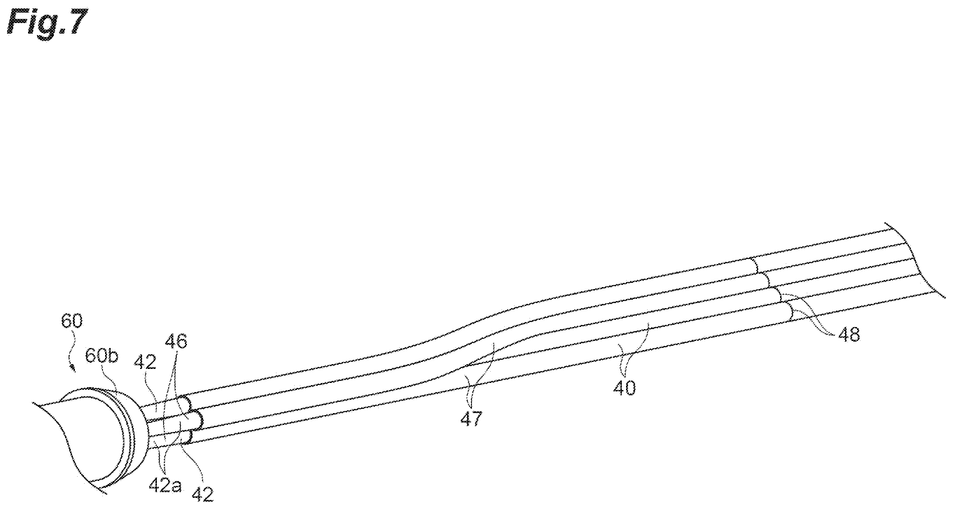

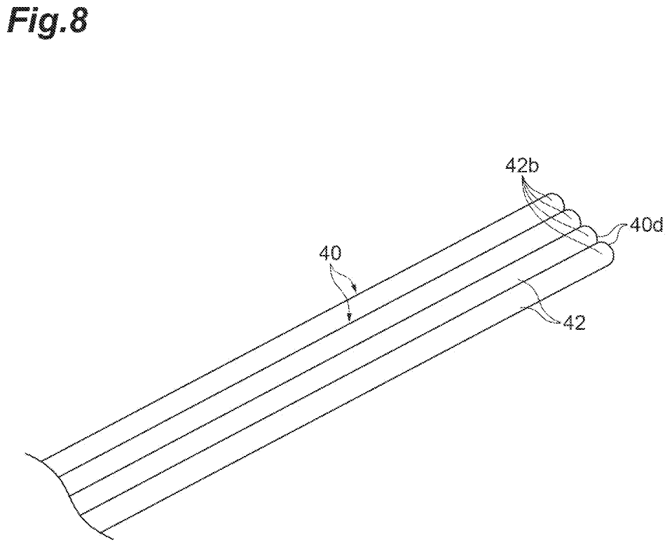

FIGS. 7 and 8 are perspective views illustrating the plurality of optical fibers 40 outside the ferrule 50 and the flange 60. As illustrated in FIG. 7, the plurality of optical fibers 40 extend from a rear end 60b of the flange 60 to the rear side of the flange 60. The plurality of optical fibers 40 is changed from a two-dimensional array to a one-dimensional arrangement in the arrangement changing portion 47 separated from the rear end 60b of the flange 60 by a certain distance. A portion of the plurality of optical fibers 40 behind the arrangement changing portion 47 constitutes an optical fiber ribbon. The plurality of optical fibers 40 are separated into two two-core ribbons in the arrangement changing portion 47, and further single-core separated in front of the arrangement changing portion 47. The plurality of optical fibers 40 are aligned in a two dimensional array and fixed to each other near the flange 60. In an example illustrated in FIG. 7, a plurality of coating portions 46 single-core separated and aligned in a two-dimensional array are inserted into the inner hole 61 of the flange 60 (see FIG. 3). A protective member may be provided at a boundary 48 between the arrangement changing portion 47 and the portion aligned in one-dimensional array in each the plurality of optical fibers 40 to protect the boundary 48. The protective member may collectively protect the plurality of arrangement changing portions 47 and the plurality of boundary portions 48, or may collectively protect the plurality of coating portions 46, the plurality of arrangement changing portions 47 and the plurality of boundaries 48.

FIG. 8 illustrates the vicinity of a terminal end of the plurality of optical fibers 40. As illustrated in FIG. 8, each of the plurality of optical fibers 40 further includes a terminal end surface 40d opposite to the tip surface 40c. In an example illustrated in FIG. 8, four terminal end surfaces 40d are arranged one-dimensionally (in a line).

The coating 42 of each of the plurality of optical fibers 40 includes a tip portion 42a (see FIG. 7) and a terminal end portion 42b (see FIG. 8). The tip portion 42a is adjacent to the second diameter portion 44. The terminal end portion 42b is located on a side opposite to the tip portion 42a. The coating 42 of each optical fiber 40 is fixed to the coating 42 of at least one optical fiber 40 among the other optical fibers 40. In the illustrated example, the tip portions 42a of two upper optical fibers 40 of four optical fibers 40 are fixed to each other, whereby the two optical fibers 40 are formed into a ribbon (integrated). The tip portions 42a of two lower optical fibers 40 of four optical fibers 40 are fixed to each other, whereby the two optical fibers 40 are formed into a ribbon (integrated). The terminal end portions 42b of four optical fibers 40 are fixed to the terminal end portions 42b of other adjacent optical fibers 40. As a result, in the vicinity of the terminal end of the plurality of optical fibers 40, all of the plurality of optical fibers 40 are formed into a ribbon (integrated).

The coating 42 includes a different appearance for each optical fiber 40. Specifically, in each of the plurality of optical fibers 40, the appearance of the tip portion 42a of the coating 42 and the appearance of the terminal end portion 42b of the coating 42 each include color or hue. In each of the plurality of optical fibers 40, the color or hue of the tip portion 42a and the color or hue of the terminal end portion 42b correspond to each other (for example, coincide with each other). The color or hue of the coating 42 is different for each optical fiber 40. As an example, the coatings 42 of four optical fibers 40 each include gray, pink, green, and orange. The coating 42 may not be formed from a single material. The coatings 42 may be formed so as to form a plurality of concentric layers around the central axis of the optical fiber 40 in the cross-section orthogonal to the longitudinal direction of the optical fiber 40. Alternatively, the color or hue of the coating 42 located in the outermost layer in each optical fiber 40 may be different for each optical fiber 40.

As illustrated in FIG. 3, the ferrule 50 extends along the longitudinal direction A. The ferrule 50 is, for example, a cylindrical member made of ceramic such as zirconia, glass, or metal. The ferrule 50 collectively holds the tip portions of the plurality of optical fibers 40. The ferrule 50 has a front end 50a, a rear end 50b, an end surface 50c, and an inner hole 51 (first fiber accommodating hole). The front end 50a is a front end in the longitudinal direction A. The rear end 50b is located on a side opposite to the front end 50a in the longitudinal direction A. The end surface 50c is located at the front end 50a. The inner hole 51 is a through hole reaching the front end 50a from the rear end 50b, and accommodates the plurality of optical fibers 40 as illustrated in FIG. 5.

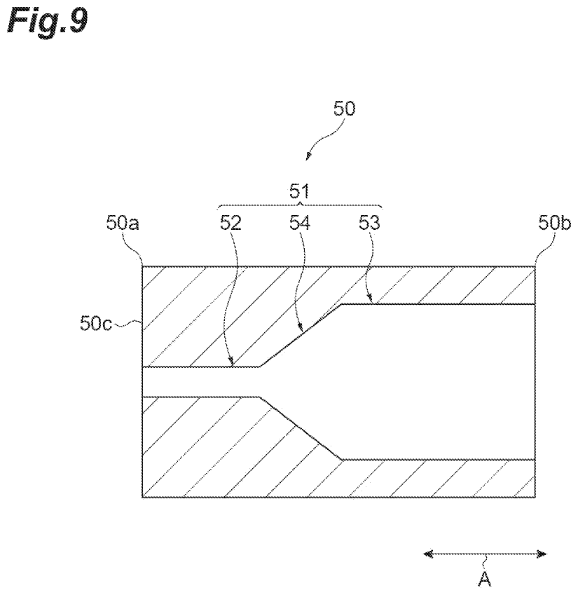

FIG. 9 is a cross-sectional view schematically illustrating the inner hole 51. The inner hole 51 includes a first portion 52, a second portion 53, and an inner diameter transition portion 54. The first portion 52 is located at the front end 50a. The second portion 53 is located at the rear end 50b. The inner diameter transition portion 54 connects the first portion 52 and the second portion 53 to each other. The first portion 52 extends from the front end 50a along the longitudinal direction A. The inner diameter of the first portion 52 is smaller than the inner diameter of the second portion 53. The inner diameter of the first portion 52 is the same as or slightly larger than the diameter of the circumscribed circle of the bundle of the first diameter portions 43 of the plurality of optical fibers 40. The inner diameter of the first portion 52 is, for example, 90 μm or more and 100 μm or less. The inner diameter transition portion 54 is continuous from the first portion 52 and extends along the longitudinal direction A. The inner diameter of the inner diameter transition portion 54 coincides with the inner diameter of the first portion 52 at the boundary with the first portion 52. The inner diameter of the inner diameter transition portion 54 increases from the first portion 52 toward the second portion 53, and coincides with the inner diameter of the second portion 53 at the boundary with the second portion 53. The inner diameter transition portion 54 may have a tapered shape. The inner diameter transition portion 54 may have a curvature in the cross-section. The second portion 53 is continuous from the inner diameter transition portion 54 and extends along the longitudinal direction A. In other words, in the longitudinal direction A, the inner diameter transition portion 54 is located between the first portion 52 and the second portion 53. The inner diameter of the second portion 53 is, for example, 300 μm or more and 400 μm or less.

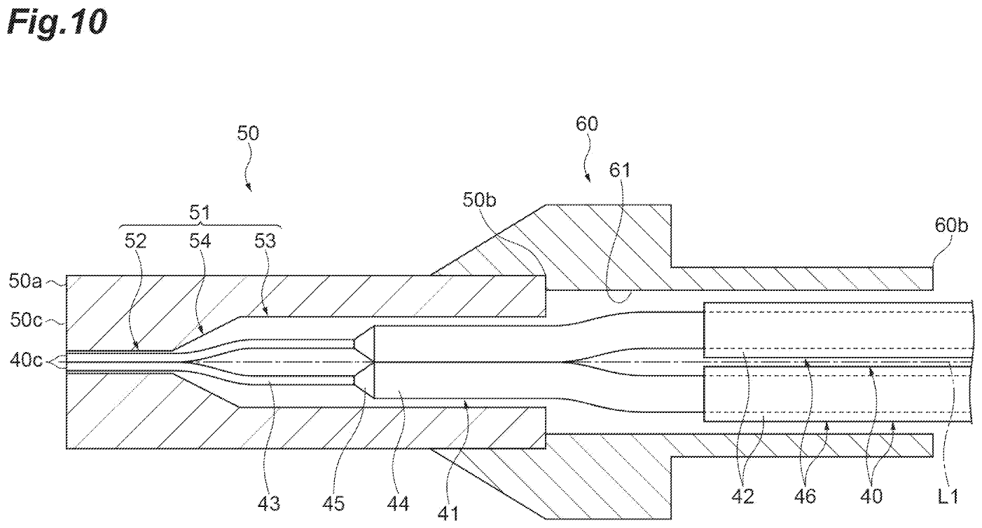

FIG. 10 is a schematic cross-sectional view illustrating the plurality of optical fibers 40 inserted into the inner hole 51 of the ferrule 50 and the inner hole 61 (described below) of the flange 60. The ferrule 50 holds the first diameter portion 43, the tapered portion 45, and the second diameter portion 44. A part of the first diameter portion 43 of each of the plurality of optical fibers 40 is inserted into the first portion 52 and the inner diameter transition portion 54 of the inner hole 51. The rest of the first diameter portion 43 of the plurality of optical fibers 40, the tapered portion 45, and a part of the second diameter portion 44 are inserted into the second portion 53 of the inner hole 51.

The plurality of optical fibers 40 are fixed to the ferrule 50 with an adhesive. Specifically, the first diameter portion 43. the tapered portion 45, and the second diameter portion 44 are fixed to the inner hole 51 with an adhesive 28 (see FIG. 5) such that each tip surface 40c of the plurality of optical fibers 40 is exposed at the end surface 50c of the ferrule 50. The first diameter portion 43, the tapered portion 45, and the second diameter portion 44 are bonded and fixed to each other with the adhesive 28 injected into a gap with the inner hole 51. The adhesive 28 is, for example, a thermosetting epoxy-based adhesive. After the adhesive 28 is injected into a predetermined place, the adhesive 28 can be cured by heating. The length of the ferrule 50 in the longitudinal direction A is, for example, 6 mm or more and 8 mm or less. In a case where the ferrule 50 is made of glass, the adhesive 28 may be an ultraviolet curable epoxy-based adhesive or an ultraviolet curable acryl-based adhesive.

As illustrated in FIG. 10, the flange 60 holds a rear end portion of the ferrule 50. The flange 60 is a tubular member accommodating the plurality of optical fibers 40 thereinside. The flange 60 has the inner hole 61 (second fiber accommodating hole). The inner hole 61 is a through hole extending along the longitudinal direction A. The inner hole 61 communicates with the inner hole 51 at the rear end 50b of the ferrule 50. The inner hole 51 and the inner hole 61 has the same central axis L1. A boundary between the second diameter portion 44 of each of the plurality of optical fibers 40 and the coating portion 46 is inserted into the inner hole 61. That is, the rest of the second diameter portion 44 and a part of the coating portion 46 are inserted into the inner hole 61. The coatings 42 of the portion of the second diameter portion 44 accommodated in the inner hole 61 and the portion of the coating portion 46 accommodated in the inner hole 61 may be fixed in the flange 60 with an adhesive. The flange 60 is made of, for example, glass, a metal, or a resin. In a case where four optical fibers 40 each having the coating 42 having an outer diameter of 250 μm are bundled and inserted into the inner hole 61, the diameter of the circumscribed circle of the bundle is 604 μm. In this case, the inner diameter of the inner hole 61 is 604 μm or more.

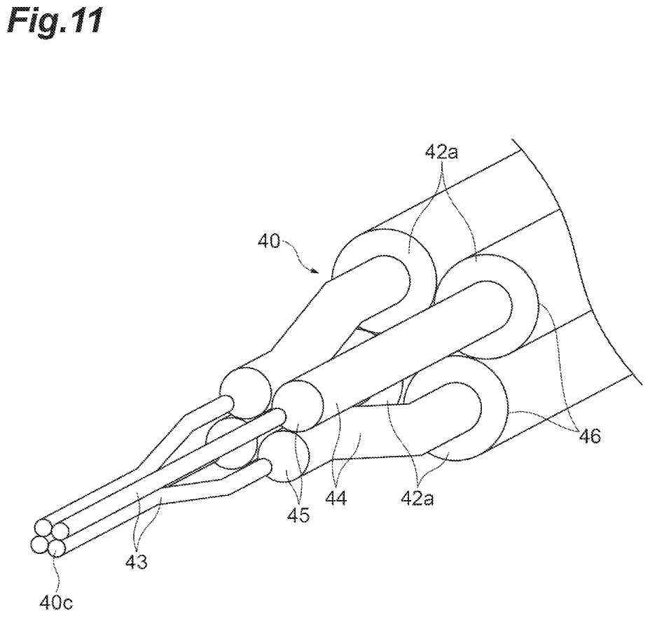

FIG. 11 is a perspective view illustrating a form of the plurality of optical fibers 40 in the inner hole 51 and the inner hole 61. The first diameter portion 43 of each optical fiber 40 does not cross the first diameter portion 43 of another optical fiber 40 in the inner hole 51 of the ferrule 50. Here, crossing means that the relative positional relationship of the first diameter portions 43 of the plurality of optical fibers 40 change between one end and the other end of the first diameter portion 43 in the longitudinal direction A. The crossing means, for example, that the plurality of optical fibers 40 are intertwined like a braid. The arrangement of the tip surfaces 40c of the plurality of optical fibers 40 in the front end 50a of the ferrule 50 is not deviated in the circumferential direction about the central axes L1 of the inner holes 51 and 61 with respect to the arrangement of the coating portions 46 of the plurality of optical fibers 40 in the inner hole 61 of the flange 60. Alternatively, even if the arrangement of the tip surfaces 40c of the plurality of optical fibers 40 in the front end 50a of the ferrule 50 is deviated from the arrangement of the coating portions 46 of the plurality of optical fibers 40 in the inner hole 61 of the flange 60, the deviation is less than 90 degrees at an angle around the central axis L1. In a case where the deviation is allowed as required characteristics of products, either the crossing between the first diameter portions 43 or the deviation of 90 degrees or more may occur.

Next, a method for manufacturing the optical connection structure 1 will be described. First, the first optical connector 10 including the structure 100 is manufactured. Specifically, first, the MCF 12, the ferrule 14, and the flange 16 are prepared. In the MCF 12, each core 12a is arranged in a predetermined manner. For example, in the MCF 12, each of the cores 12a has a square arrangement of four cores 12a.

Subsequently, the MCF 12 is inserted into the inner hole of the flange 16 and the inner hole 14a of the ferrule 14, and the tip portion 12d of the MCF 12 is fitted into the inner hole 14a of the ferrule 14. At this time, the tip surface 12c of the MCF 12 may coincide with the end surface 14b of the ferrule 14. After the tip portion 12d of the MCF 12 is fitted into the inner hole 14a of the ferrule 14, the tip surface 12c of the MCF 12 may be polished together with the end surface 14b of the ferrule 14. For example, in a case where polishing is performed so as to enable PC (Physical contact) connection, the curvature radius of the end surface 14b of the ferrule 14 is, for example, 1 mm or more and 50 mm or less. The structure 100 is prepared by accommodating the ferrule 14 and the flange 16 in a housing (not illustrated). Then, the first optical connector 10 is prepared by accommodating the ferrule 14 and the flange 16 in a housing (not illustrated).

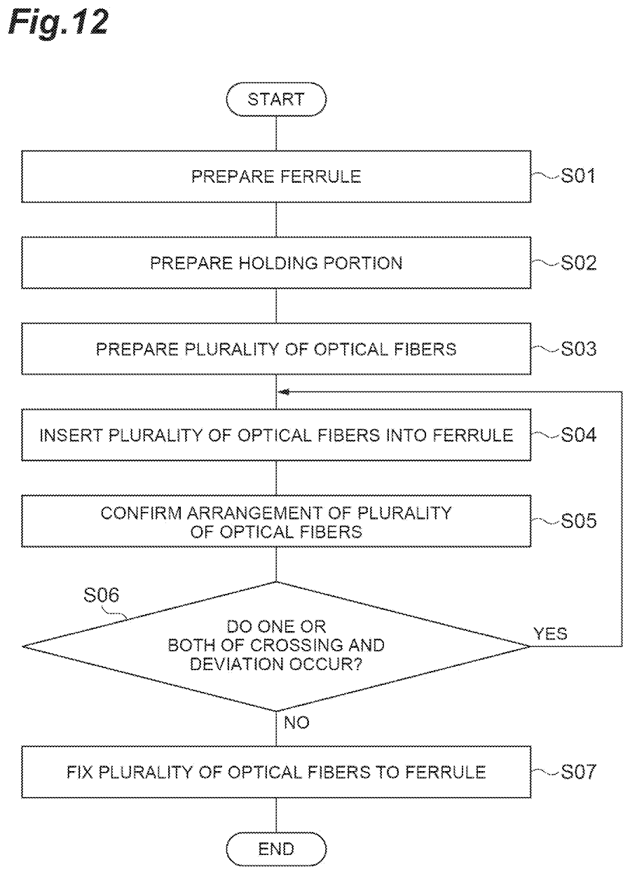

Next, the second optical connector 20 including the optical fiber bundle 200 is manufactured. Hereinafter, a method for manufacturing the optical fiber bundle 200 will be described. FIG. 12 is a flowchart illustrating a method for manufacturing the optical fiber bundle 200. First, the ferrule 50 having the front end 50a, the rear end 50b, and the inner hole 51 is prepared (Step S01: step of preparing a ferrule). Next, the flange 60 having the inner hole 61 is prepared (Step S02: step of preparing a holding portion). The preparation of the flange 60 may be performed before the preparation of the ferrule 50. The preparation of the flange 60 and the preparation of the ferrule 50 may be performed in parallel.

Subsequently, the plurality of optical fibers 40 each having the glass fiber 41 and the coating 42 are prepared (Step S03: step of preparing a plurality of optical fibers). In the step of preparing the plurality of optical fibers 40, the first diameter portion 43 and the tapered portion 45 are formed by subjecting the glass fiber of the optical fiber 40 to diameter reduction process. As an example, only the tip portion of the ribbon including the plurality of optical fibers 40 is single-core separated, and the tip portion is immersed in etchant to be chemically etched. The etchant is, for example, hydrofluoric acid. As described above, by single-core separating only the tip portion of the ribbon and keeping the portions other than the tip portion as the ribbon, scattering and entanglement of the plurality of optical fibers 40 from the step of inserting the plurality of optical fibers 40 (Step S04) to the fixing step (Step S07) are suppressed, so that workability is improved. The preparation of the plurality of optical fibers 40 may be performed before the preparation of one or both of the flange 60 and the ferrule 50. Alternatively, the preparation of the plurality of optical fibers 40 may be performed in parallel with the preparation of one or both of the flange 60 and the ferrule 50. The step of preparing the plurality of optical fibers 40 (Step S03) may include a step of changing the appearance of the coating 42. In the changing step, the appearance of the coating 42 may be changed by applying a color to the coating 42 using a pen or the like.

Subsequently, the plurality of optical fibers 40 are inserted into the inner hole 61 of the flange 60 and the inner hole 51 of the ferrule 50 (Step S04: inserting step). In this step, the plurality of optical fibers 40 are collectively inserted into the inner hole 61 of the flange 60 and the inner hole 51 of the ferrule 50, and the plurality of optical fibers 40 are arranged in the inner hole 51 of the ferrule 50. Specifically, as illustrated in FIG. 10, the first diameter portions 43 of the plurality of optical fibers 40 are inserted into the first portion 52 of the inner hole 51 of the ferrule 50. At the same time, the tapered portions 45 of the plurality of optical fibers 40 are inserted into the second portion 53 of the inner hole 51 of the ferrule 50. At the same time, the boundary between the second diameter portion 44 of each of the plurality of optical fibers 40 and the coating portion 46 is inserted into the inner hole 61 of the flange 60. At this time, the plurality of optical fibers 40 are arranged in the ferrule 50 so as to correspond to the arrangement of the cores 12a of the MCF 12 (for example, two-dimensionally in a cross-section intersecting the longitudinal direction A). At this time, each optical fiber 40 is arranged such that the claddings 40b are in contact with each other and are also in contact with the inner hole 51 of the ferrule 50. The plurality of optical fibers 40 may be inserted into the ferrule 50 after the coating 42 is fixed to each other with aligning the single-core separated portions of the coating portion 46 in the same manner as the arrangement of the first diameter portions 43. In this case, the possibility of occurrence of an crossing inside the ferrule 50 is reduced. Since the deviation between the coating portions 46 in the longitudinal direction A is suppressed, the variation in the insertion amount of the optical fiber 40 into the ferrule 50 is reduced. As a result, the radius of curvature of a part of the optical fibers 40 inside the flange 60 is prevented from becoming small.

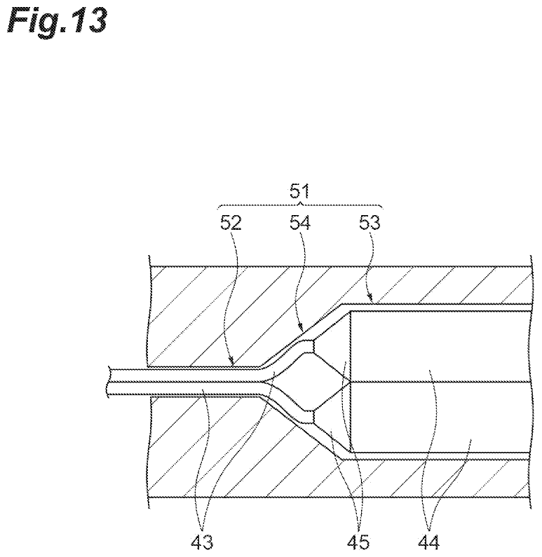

FIG. 13 is a view illustrating a state in the middle of inserting the plurality of optical fibers 40 into the ferrule 50. As illustrated in FIG. 13, when the plurality of optical fibers 40 are inserted deep into the inner hole 51 of the ferrule 50, the optical fiber 40 comes into contact with the inner diameter transition portion 54 of the ferrule 50. At this time, the optical fiber 40 cannot move toward the front end 50a of the ferrule 50 (see FIG. 10) and stops. In this state, bending of the first diameter portion 43 of the optical fiber 40 increases in the inner diameter transition portion 54, and bending loss and breakage may occur in the first diameter portion 43. Therefore, in the inserting step, as illustrated in FIG. 13, the optical fiber 40 is inserted until abutting the inner diameter transition portion 54, and then the optical fiber 40 is pulled back by a certain distance as illustrated in FIG. 10. Thereby, it is possible to insert the first diameter portion 43 into the first portion 52 while bending the first diameter portion 43 with a small curvature in the second portion 53 and the inner diameter transition portion 54 of the inner hole 51 of the ferrule 50. As a result, bending loss and breakage in the first diameter portion 43 can be suppressed.

Subsequently, the arrangement of the plurality of optical fibers 40 at the front end 50a of the ferrule 50 is confirmed (Step S05: confirming step). Specifically, by propagating light from the terminal end surface 40d of each of the plurality of optical fibers 40 and observing the tip surface 40c of each of the plurality of optical fibers 40, the arrangement of the plurality of optical fibers 40 at the front end 50a of the ferrule 50 is confirmed. That is, the correspondence relationship between the terminal end surfaces 40d and the tip surfaces 40c of the plurality of optical fibers 40 is confirmed by propagating light from the terminal end surfaces 40d of the plurality of optical fibers 40. As an example, red laser light is incident from the terminal end surface 40d of the optical fiber 40. In this case, at the front end 50a of the ferrule 50, red laser light is emitted from the core 40a of the optical fiber 40. At this time, the tip surfaces 40c of the plurality of optical fibers are enlarged and observed with a microscope or the like to record the position where the red laser light is emitted. As a result, the correspondence relationship between the terminal end surfaces 40d and the tip surfaces 40c of the plurality of optical fibers 40 can be confirmed. The light incident on the optical fiber 40 may be visible light.

Subsequently, it is determined whether one or both of crossing and deviation occur (Step S06: determining step). The crossing is crossing between the first diameter portion 43 of one optical fiber 40 among the plurality of optical fibers 40 in the inner hole 51 of the ferrule 50 and the first diameter portion 43 of the other optical fiber 40. The deviation is deviation between the arrangement of the plurality of optical fibers 40 at the front end 50a of the ferrule 50 and the arrangement of the plurality of optical fibers 40 in the inner hole 61. The deviation is deviation of a predetermined angle or more along the circumferential direction around the central axis L1 of the inner hole 51. The predetermined angle is, for example, 90 degrees. The deviation generated when the plurality of optical fibers 40 rotate together is referred to as torsion.

Hereinafter, the determining step (Step S06) will be described in more detail. First, based on the appearance of the coating 42 of the optical fiber 40, the correspondence relationship between the coating portions 46 of the plurality of optical fibers 40 at the rear end 50b of the ferrule 50 and the terminal end surfaces 40d of the plurality of optical fibers 40 is confirmed. Next, the correspondence relationship between the terminal end surface 40d and the tip surface 40c confirmed in Step S05 is applied to the correspondence relationship between the coating portion 46 in the flange 60 and the terminal end surface 40d, thereby confirming the correspondence relationship between the coating portion 46 in the flange 60 and the tip surface 40c at the front end 50a of the ferrule 50.

Subsequently, based on the correspondence relationship between the coating portion 46 in the flange 60 and the tip surface 40c at the front end 50a of the ferrule 50, the arrangement of the coating portions 46 of the plurality of optical fibers 40 in the inner hole 61 (hereinafter, referred to as “coating portion arrangement”) is compared with the arrangement of the plurality of optical fibers 40 at the front end 50a of the ferrule 50 (hereinafter, referred to as “tip surface arrangement”). Finally, it is determined whether one or both of deviation and crossing occur based on the comparison result between the coating portion arrangement and the tip surface arrangement.

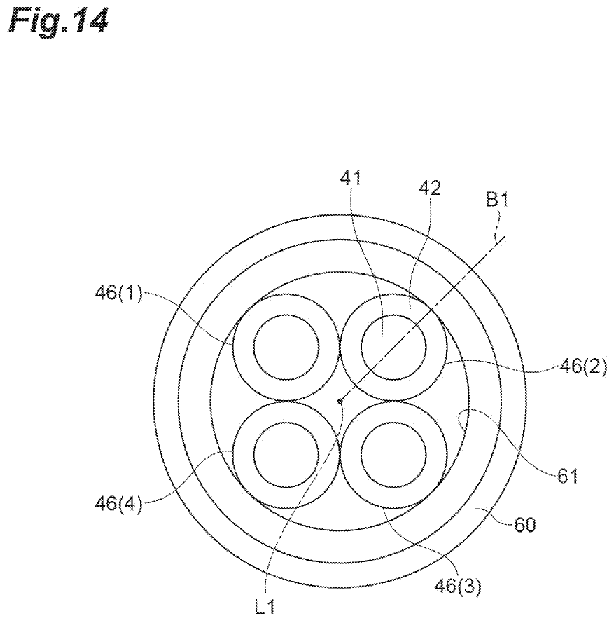

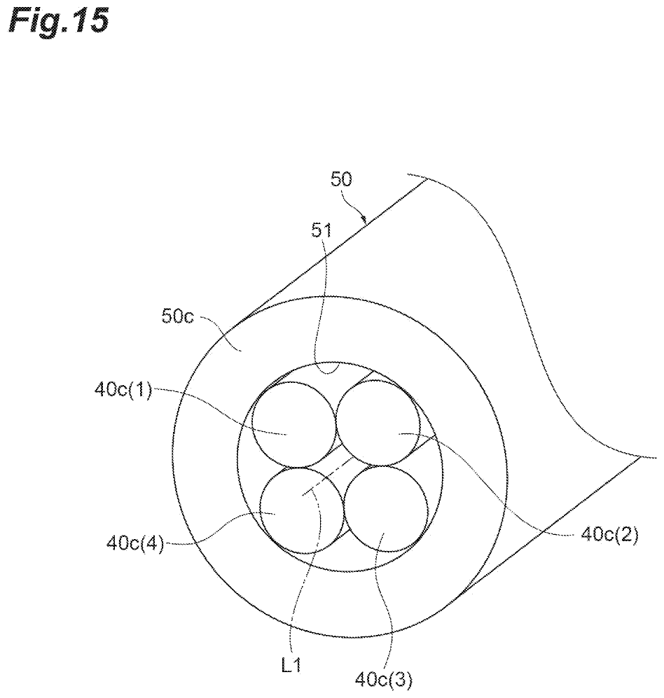

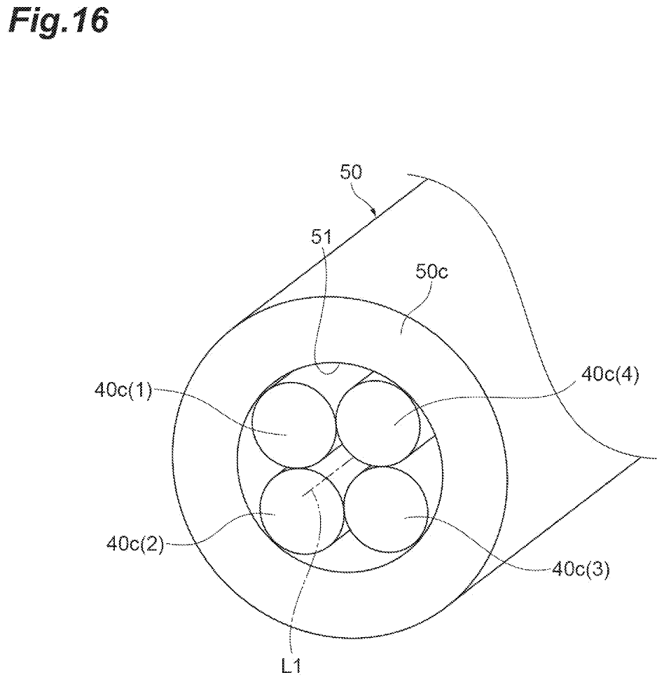

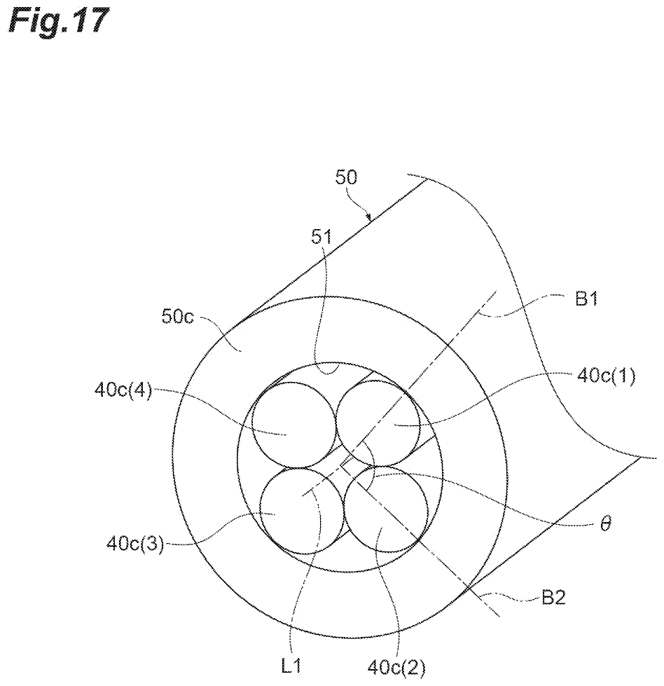

FIG. 14 is a view illustrating an example of coating portion arrangement. FIGS. 15 to 17 are views illustrating examples of the tip surface arrangement. In the example illustrated in FIG. 14, the coating portions 46(1), 46(2), 46(3), and 46(4) are arranged clockwise in this order. In the example illustrated in FIG. 15, the tip surfaces 40c(1), 40c(2), 40c(3), and 40c(4) are arranged clockwise in this order. In the example illustrated in FIG. 16, the tip surfaces 40c(1), 40c(2), 40c(3), and 40c(4) are arranged clockwise in the order of the tip surfaces 40c(1), 40c(4), 40c(3), and 40c(2). In the example illustrated in FIG. 17, the tip surfaces 40c(1), 40c(2), 40c(3), and 40c(4) are arranged clockwise in the order of the tip surfaces 40c(4), 40c(1), 40c(2), and 40c(3).

For example, when the coating portion arrangement illustrated in FIG. 14 is compared with the tip surface arrangement illustrated in FIG. 15, the clockwise arrangement order of the coating portions 46 coincides with the clockwise arrangement order of the tip surfaces 40c. In this case, it can be determined that no crossing occurs in the inner hole 51 of the ferrule 50. In addition, when the coating portion arrangement illustrated in FIG. 14 is compared with the tip surface arrangement illustrated in FIG. 15, there is no deviation along the circumferential direction around the central axis L1 of the inner hole 51 between the tip surface 40c(1) and the coating portion 46(1). In other words, the angular deviation between the tip surface 40c(1) and the coating portion 46(1) is 0 degrees. In this case, in the inner hole 51 of the ferrule 50, it can be determined that no deviation in the circumferential direction around the central axis L1 occurs between the tip surface 40c and the coating portion 46. In this example, since neither the crossing of the plurality of optical fibers 40 nor the deviation between the tip surface 40c and the coating portion 46 occurs, the curvature radius of the first diameter portion 43 in the inner hole 51 of the ferrule 50 has a large value of, for example, 32.5 mm or more.

For example, when the coating portion arrangement illustrated in FIG. 14 is compared with the tip surface arrangement illustrated in FIG. 16, the clockwise arrangement order of the coating portions 46 does not coincide with the clockwise arrangement order of the tip surfaces 40c. In this case, it can be determined that crossing of the plurality of optical fibers 40 occurs in the inner hole 51 of the ferrule 50. When the coating portion arrangement illustrated in FIG. 14 is compared with the tip surface arrangement illustrated in FIG. 16, there is no deviation along the circumferential direction around the central axis L1 of the inner hole 51 between the tip surface 40c(1) and the coating portion 46(1) (in other words, the deviation between the tip surface 40c(1) and the coating portion 46(1) is 0 degrees). Similarly, no deviation along the circumferential direction around the central axis L1 of the inner hole 51 occurs between the tip surface 40c(2) and the coating portion 46(2), between the tip surface 40c(3) and the coating portion 46(3), and between the tip surface 40c(4) and the coating portion 46(4). In this case, in the inner hole 51 of the ferrule 50, it can be determined that no deviation in the circumferential direction around the central axis L1 occurs between the tip surface 40c and the coating portion 46. In this example, since the crossing of the plurality of optical fibers 40 occurs, the curvature radius of the first diameter portion 43 in the inner hole 51 of the ferrule 50 has a small value of, for example, 17.0 mm or less.

For example, when the coating portion arrangement illustrated in FIG. 14 is compared with the tip surface arrangement illustrated in FIG. 17, the clockwise arrangement order of the coating portions 46 coincides with the clockwise arrangement order of the tip surfaces 40c. In this case, it can be determined that no crossing of the plurality of optical fibers 40 occurs in the inner hole 51 of the ferrule 50. However, when the coating portion arrangement illustrated in FIG. 14 is compared with the tip surface arrangement illustrated in FIG. 17, deviation of an angle θ along the circumferential direction around the central axis L1 of the inner hole 51 occurs between the tip surface 40c and the coating portion 46. The angle θ is an angle formed by a straight line B1 and a straight line B2. The straight line B1 passes through the center of the inner hole 61 and the center of a certain coating portion 46 in FIG. 14. The straight line B2 passes through the center of the inner hole 51 and the center of the tip surface 40c in FIG. 17. In a case where the angle θ is less than the predetermined angle (for example, less than 90 degrees), it can be determined that there is no deviation between the tip surface 40c and the coating portion 46 in the inner hole 51 of the ferrule 50. In a case where the angle θ is the predetermined angle or more (for example, 90 degrees or more), it can be determined that deviation occurs between the tip surface 40c and the coating portion 46 in the inner hole 51 of the ferrule 50. In a case where the deviation of 90 degrees or more occurs, the curvature radius of the first diameter portion 43 in the inner hole 51 of the ferrule 50 has a small value of, for example, 17.0 mm or less.

In a case where it is determined that one or both of crossing and deviation occur (Step S06: YES), the inserting step (Step S04), the confirming step (Step S05), and the determining step (Step S06) are executed again. In this case, in the inserting step, the plurality of optical fibers 40 may be inserted into the ferrule 50 again. Alternatively, in the inserting step, vibration may be applied to the ferrule 50 without removing the plurality of optical fibers 40 from the ferrule 50. Alternatively, in the inserting step, the optical fiber 40 may be moved along the longitudinal direction A. In a case where it is determined that both crossing and deviation do not occur (Step S06: NO), the process proceeds to the fixing step (Step S07).

In the determining step (Step S06), only whether or not crossing occurs may be determined. In a case where it is determined that crossing occurs (Step S06: YES), the inserting step (Step S04), the confirming step (Step S05), and the determining step (Step S06) are executed again. In a case where it is determined that crossing does not occur (Step S06: NO), the process proceeds to the fixing step (Step S07). In the determining step (Step S06), only whether or not deviation occurs may be determined. In a case where it is determined that deviation occurs (Step S06: YES), the inserting step (Step S04), the confirming step (Step S05), and the determining step (Step S06) are executed again. In a case where it is determined that deviation does not occur (Step S06: NO), the process proceeds to the fixing step (Step S07).

Subsequently, the plurality of optical fibers 40 are fixed to the ferrule 50 with an adhesive (Step S07: fixing step). Specifically, first, the adhesive 28 is injected into a gap between the inner hole 51 of the ferrule 50 and the plurality of optical fibers 40. At this time, the adhesive 28 is sufficiently injected so as to cover the tip surface 40c of the optical fiber 40 and the end surface 50c of the ferrule 50. Thereafter, the adhesive 28 is thermally cured, for example, by heating. As a result, the plurality of optical fibers 40 are fixed to the ferrule 50. Thereafter, the end surface 50c of the ferrule 50 is polished together with the tip surface 40c of the optical fiber 40. By the polishing, the adhesive on the tip surface 40c and the end surface 50c is removed, and the tip surface 40c and the end surface 50c are exposed. In a case where polishing is performed so as to enable PC connection, the curvature radius of the end surface 50c of the ferrule 50 is, for example, 1 mm or more and 50 mm or less, as described above. As described above, the optical fiber bundle 200 is prepared. Then, the second optical connector 20 is prepared by accommodating the ferrule 50 and the flange 60 in a housing (not illustrated).

Subsequently, the split sleeve 30 is prepared. Then, in the split sleeve 30, the first optical connector 10 and the second optical connector 20 are connected to each other such that the end surface 14b of the ferrule 14 and the end surface 50c of the ferrule 50 are brought into contact with each other. Subsequently, alignment is performed by rotating one or both of the ferrule 14 and the ferrule 50 in the split sleeve 30 such that each core 12a of the MCF 12 and each corresponding core 40a of the plurality of optical fibers 40 are optically coupled.

Subsequently, after the alignment is completed, the first optical connector 10 and the second optical connector 20 are fixed in a state of being pressed against each other. At this time, the ferrule 14 and the ferrule 50 may be brought into a pressed state by friction with the split sleeve 30 using a pressing member, or the ferrule 14 and the ferrule 50 may be bonded and fixed with an adhesive. As described above, the optical connection structure 1 can be manufactured.

Subsequently, a determination method for determining the states of the plurality of optical fibers 40 in the inner hole 51 of the ferrule 50 when the plurality of optical fibers 40 are inserted from the rear end 50b of the ferrule 50 into the inner hole 51 provided in the ferrule 50 will be described. First, the arrangement of the plurality of optical fibers 40 at the front end 50a of the ferrule 50 is confirmed (Step S05: confirming step). Then, it is determined whether one or both of crossing and deviation occur (Step S06: determining step).

Functions and effects obtained by the method of manufacturing the optical fiber bundle 200, the optical fiber bundle 200, the optical connection structure 1, and the determination method according to the present embodiment described above will be described. In a conventional optical fiber bundle, there is a possibility that a bending loss in a plurality of optical fibers is increased inside a ferrule. Specifically, in manufacturing the optical fiber bundle, when the plurality of optical fibers are inserted from a rear end of a ferrule, crossing or twisting of the plurality of optical fibers may occur. For example, the plurality of optical fibers may be twisted like a rope to increase rigidity and inserted in contact with an inner hole of the ferrule. This twisting may cause the bending loss of the optical fibers. Due to above, there is a possibility that the bending of the plurality of optical fibers increases inside the ferrule, and the bending loss of the plurality of optical fibers increases.

In order to suppress twisting of the plurality of optical fibers, it is conceivable to open a gap between the ferrule and the optical fibers so as not to generate frictional force as much as possible. However, if there is a gap between the ferrule and the optical fibers, the arrangement of the tip surfaces of the plurality of optical fibers at the tip end of the optical fiber bundle is collapsed, and the positions of the cores of the plurality of optical fibers and the cores of the MCF tend to be deviated. This may result in optical loss. Therefore, it is desirable to allow the occurrence of twisting to some extent and to observe the degree of twisting in the manufacturing process.

In the method of manufacturing the optical fiber bundle 200, in a case where one or both of the crossing and the deviation occur in the step of determining (Step S06), the step of inserting (Step S04), the step of confirming (Step S05), and the step of determining (Step S06) are performed again before the step of fixing (Step S07). According to this configuration, it is possible to manufacture the optical fiber bundle 200 in which one or both of crossing and twisting of the plurality of optical fibers 40 inside the inner hole 51 of the ferrule 50 is suppressed. As a result, it is possible to manufacture an optical fiber bundle 200 in which the bending loss of the plurality of optical fibers 40 is reduced. Each of the coatings 42 of the plurality of optical fibers 40 includes a different appearance for each optical fiber 40. According to this configuration, the coating portions 46 of the plurality of optical fibers 40 can be easily distinguished based on the appearances of the coatings 42. Accordingly, it is possible to confirm the correspondence between the coating portions 46 of the plurality of optical fibers 40 at the rear end 50b of the ferrule 50 and the terminal end surfaces 40d of the plurality of optical fibers 40. Here, by conducting light from the terminal end surfaces 40d of the plurality of optical fibers 40 and confirming the correspondence between the terminal end surfaces 40d and the tip surfaces 40c of the plurality of optical fibers 40, it is possible to confirm the correspondence between the coating portions 46 of the plurality of optical fibers 40 at the rear end 50b of the ferrule 50 and the tip surfaces 40c of the plurality of optical fibers 40 at the front end 50a of the ferrule 50. Therefore, it is possible to compare the arrangement of the coating portions 46 of the plurality of optical fibers 40 at the rear end 50b of the ferrule 50 with the arrangement of the tip surfaces 40c of the plurality of optical fibers 40 at the front end 50a of the ferrule 50. As a result, in the step of determining (Step S06), it is possible to easily determine whether one or both of the crossing and the deviation occur.

In the method of manufacturing the optical fiber bundle 200, in the step of changing the appearance of the coating 42, the appearance of the coating 42 may be changed by coloring. In this case, the appearance of the coating 42 can be easily changed.

In the optical fiber bundle 200 according to the present embodiment, has at least one configuration of a first configuration and a second configuration. The first configuration is a configuration in which the first diameter portion 43 of one optical fiber 40 of the plurality of optical fibers 40 has no crossing within the ferrule 50 with first diameter portions 43 of the other optical fibers 40 of the plurality of optical fibers 40. The second configuration is a configuration in which an arrangement of the tip surfaces 40c of the plurality of optical fibers 40 at the front end 50a of the ferrule 50 has no deviation with an arrangement of the coating portions 46 of the plurality of optical fibers 40 at in the inner hole 61 of the flange 60 along a circumferential direction around the central axis L1 of the inner hole 51 of the ferrule 50, or has the deviation of less than 90 degrees. According to such a configuration, one or both of crossing and twisting of the plurality of optical fibers 40 within the inner hole 51 of the ferrule 50 is suppressed. As a result, the bending loss of the plurality of optical fibers 40 can be reduced. The coating 42 of each of the plurality of optical fibers 40 includes a different appearance for each optical fiber 40. According to this configuration, the plurality of optical fibers 40 can be easily distinguished.

Here, it is also conceivable to provide the ferrule with a cutaway structure to visualize the internal twisting and crossing of the ferrule. However, the cost of forming the ferrule increases and the twisting cannot be suppressed. On the other hand, in the ferrule 50 of the optical fiber bundle 200 according to the present embodiment, the bending loss of the plurality of optical fibers 40 can be reduced while suppressing an increase in manufacturing cost.

As in the present embodiment, in the optical fiber bundle 200, the appearance of the tip portion 42a of the coating 42 and the appearance of the terminal end portion 42b of the coating 42 may include colors or hues corresponding to each other in each of the plurality of optical fibers 40. In this case, the plurality of optical fibers 40 can be easily distinguished at the tip portion 42a and the terminal end portion 42b of the coating 42.

As in the present embodiment, in the optical fiber bundle 200, the appearance of the coating 42 of each of the plurality of optical fibers 40 includes a different color or hue for each optical fiber 40. In this case, the plurality of optical fibers 40 can be easily distinguished.

As in the present embodiment, in the optical fiber bundle 200, at least a part of the plurality of optical fibers 40 may be formed into an optical fiber ribbon. In this case, deviation of the plurality of optical fibers 40 along the longitudinal direction A can be suppressed, and an increase in bending of the plurality of optical fibers 40 in the inner hole 61 of the flange 60 can be suppressed. This makes it possible to reduce the bending loss of the plurality of optical fibers 40.

The optical connection structure 1 according to the present embodiment includes: the second optical connector 20 having the above-mentioned optical fiber bundle 200 and the first optical connector 10 having the MCF 12 including the plurality of cores 12a extending along the longitudinal direction A and the cladding 12b covering the plurality of cores 12a, and the ferrule 14 holding the tip portion 12d of the MCF 12. When the second optical connector 20 is connected to the first optical connector 10, the cores 40a of the plurality of optical fibers 40 are optically coupled to the plurality of cores 12a of the MCF 12, respectively. In this optical connection structure 1, bending loss in the plurality of optical fibers 40 can be reduced.

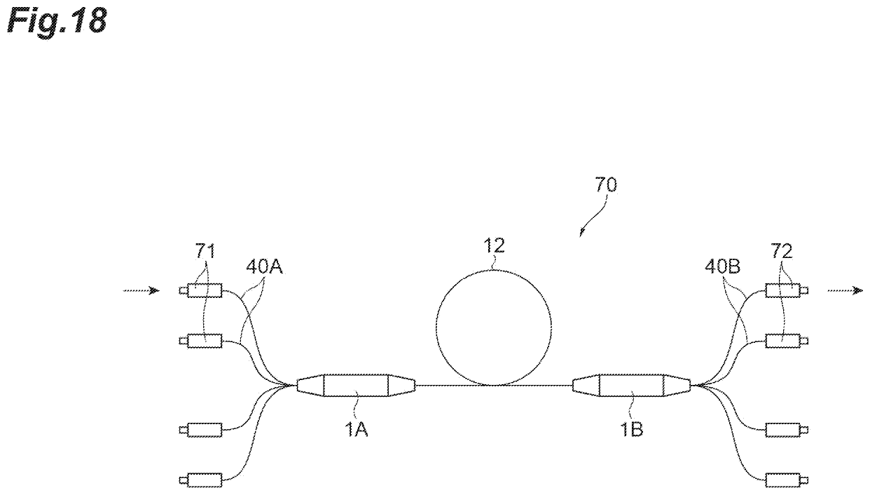

As in the present embodiment, the optical connection structure 1 optically couples the MCF 12 and the plurality of optical fibers 40. According to such a configuration, the optical connection structure 1 can constitute a fan-in/fan-out (FIFO) device of the MCF 12. FIG. 18 is a view illustrating an FIFO 70. The FIFO 70 has a plurality of connectors 71, a plurality of optical fibers 40A, an optical connection structure 1A, the MCF 12, an optical connection structure 1B, a plurality of optical fibers 40B, and a plurality of connectors 72. The plurality of connectors 71 are connected to the plurality of optical fibers 40A, respectively. The plurality of optical fibers 40A are optically coupled to the MCF 12 in the optical connection structure 1A. The MCF 12 is optically coupled to the plurality of optical fibers 40B in the optical connection structure 1B. The plurality of optical fibers 40B are optically coupled to the plurality of connectors 72. In the FIFO 70, a signal input from the connector 71 propagates through the optical fiber 40A, the MCF 12, and the optical fiber 40B and is output from the connector 72.

The optical connection structures 1A and 1B have the same configuration as in the optical connection structure 1. As a result, it is possible to easily perform alignment work, which is work of aligning the cores of the MCF 12 and the cores of the optical fibers 40A and 40B and fixing the cores at a position where the optical loss is minimized. In addition, the connectors 71 and 72 are attached to the optical connection structures 1A and 1B via the plurality of optical fibers 40A and 40B. According to such a configuration, in a case where the inspection of the FIFO 70 is performed after the alignment work, it is easy to repeatedly perform IL measurement (insertion loss measurement).

The connectors 71 and 72 are fusion-spliced to the optical fibers 40A and 40B by single-core fusion splicing or multi-core fusion splicing. In the case of performing fusion splicing by multi-core fusion splicing, the plurality of connectors 71 and 72 can be connected to the plurality of optical fibers 40A and 40B by one operation. In this case, the operation time can be shortened as compared with the single-core fusion splicing. In a case where the plurality of optical fibers 40A and 40B are ribbons, the plurality of connectors 71 and 72 can be easily fusion-spliced to the plurality of optical fibers 40A and 40B. Since it is not necessary to arrange and fusion-splice the optical fibers 40A and 40B alone, the operation for fusion splicing is simplified, so that the manufacturing cost of the FIFO 70 can be reduced, and a decrease in fusion splicing accuracy can be suppressed.

In the determination method according to the present embodiment, it is determined whether one or both of the crossing within the inner hole 51 of the ferrule 50 between one optical fiber 40 and another optical fiber 40 among the plurality of optical fibers 40 and the deviation between the arrangement of the tip surfaces 40c of the plurality of optical fibers 40 at the front end 50a of the ferrule 50 and the arrangement of the coating portions 46 of the plurality of optical fibers 40 at the rear end 50b of the ferrule 50, which is a deviation of a predetermined angle or more along the circumferential direction around the central axis L1 of the inner hole 51 of the ferrule 50, occur. According to this configuration, one or both of crossing and twisting of the plurality of optical fibers 40 are suppressed inside the inner hole 51 of the ferrule 50. Accordingly, in the optical fiber bundle 200, it is possible to reduce bending loss in the plurality of optical fibers 40.

The method for manufacturing the optical fiber bundle 200, the optical fiber bundle 200, the optical connection structure 1, and the determination method according to the present disclosure are not limited to the above-described embodiments, and various other modifications are possible. For example, in the embodiments described above, the appearance of the coating 42 of each of the plurality of optical fibers 40 may include a different marking for each optical fiber 40. In this case, the plurality of optical fibers 40 can be easily distinguished. In the step of preparing the plurality of optical fibers 40 (Step S03), in the step of changing the appearance of the coating 42, a different marking may be applied to the coating 42 for each optical fiber 40 by irradiating the coating 42 with a laser. In this case, the appearance of the coating 42 can be easily changed.

For example, in the above embodiment, the coating 42 of each of the plurality of optical fibers 40 may have a different outer diameter for each optical fiber 40, or may include a different material having a different color and an appearance for each optical fiber 40. In these cases, the plurality of optical fibers 40 can be easily distinguished.

For example, in the optical fiber bundle 200 of the above embodiment, each of the plurality of optical fibers 40 may include a first tape and a second tape having appearances corresponding to each other. The appearances of the first tapes of the plurality of optical fibers 40 may be different from each other. The appearances of the second tapes of the plurality of optical fibers 40 may be different from each other. The tip portion 42a of the coating 42 may be labeled with the first tape. The terminal end portion 42b of the coating 42 may be labeled with the second tape. In this case, the appearance of the coating 42 can be easily changed. In the step of changing the appearance of the coating 42, the appearance of the coating 42 may be changed by labeling the coating 42 with the first tape and the second tape. In this case, the appearance of the coating 42 can be easily changed.

What is claimed is:

1. A method for manufacturing an optical fiber bundle for optically coupling a plurality of optical fibers to a multicore optical fiber, the method comprising:
preparing a ferrule extending along a first direction, the ferrule having a front end in the first direction, a rear end opposite to the front end in the first direction, and a first fiber accommodating hole as a hole including a first portion that is located at the front end, a second portion that is located at the rear end and has a larger inner diameter than an inner diameter of the first portion, and an inner diameter transition portion that connects the first portion and the second portion to each other;
preparing a holding portion having a second fiber accommodating hole as a hole extending along the first direction and communicating with the first fiber accommodating hole at the rear end of the ferrule;
preparing a plurality of optical fibers each having a glass fiber and a coating portion, the glass fiber including a first diameter portion, a second diameter portion having a larger diameter than a diameter of the first diameter portion, a tapered portion connecting the first diameter portion and the second diameter portion, a tip surface located at a tip end of the first diameter portion, and a terminal end surface opposite to the tip surface, at least the first diameter portion, the tapered portion, and the second diameter portion extending along the first direction, and the coating portion being formed by covering a glass fiber continuous with the second diameter portion with a coating;
inserting the first diameter portion of each of the plurality of optical fibers, the tapered portion of each of the plurality of optical fibers, and a boundary between the second diameter portion of each of the plurality of optical fibers and the coating portion of each of the plurality of optical fibers into the first portion of the first fiber accommodating hole, the second portion of the first fiber accommodating hole, and the second fiber accommodating hole, respectively;
confirming an arrangement of the plurality of optical fibers at the front end of the ferrule by conducting light from the terminal end surface of each of the plurality of optical fibers and observing the tip surface of each of the plurality of optical fibers;
determining whether one or both of crossing and deviation occur, the crossing being a crossing within the ferrule between the first diameter portion of one optical fiber among the plurality of optical fibers and the first diameter portion of an other optical fiber among the plurality of optical fibers, the deviation being a deviation between an arrangement of the plurality of optical fibers at the front end of the ferrule and an arrangement of the plurality of optical fibers at the second fiber accommodating hole and being a deviation of a predetermined angle or more along a circumferential direction around a central axis of the first fiber accommodating hole and the second fiber accommodating hole; and
fixing the plurality of optical fibers to the ferrule with an adhesive, wherein
in the preparing the plurality of optical fibers, the coating of each of the plurality of optical fibers includes a different appearance for each optical fiber and is fixed to the coating of at least one optical fiber among other optical fibers, and
in a case where one or both of the crossing and the deviation occur in the determining, the inserting, the confirming and the determining are performed again before the fixing.

2. The method for manufacturing the optical fiber bundle according to claim 1, wherein the preparing the plurality of optical fibers includes changing an appearance of the coating.

3. The method for manufacturing the optical fiber bundle according to claim 2, wherein in the changing, the appearance of the coating is changed by laser irradiation.

4. The method for manufacturing the optical fiber bundle according to claim 2, wherein in the changing, the appearance of the coating is changed by coloring.

5. The method for manufacturing the optical fiber bundle according to claim 2, wherein in the changing, the appearance of the coating is changed by labeling with a tape.

6. An optical fiber bundle for optically coupling a plurality of optical fibers to a multicore optical fiber, the optical fiber bundle comprising:
a ferrule extending along a first direction, the ferrule having a front end in the first direction, a rear end opposite to the front end in the first direction, and a first fiber accommodating hole as a hole including a first portion that is located at the front end, a second portion that is located at the rear end and has a larger inner diameter than an inner diameter of the first portion, and an inner diameter transition portion that connects the first portion and the second portion to each other;
a holding portion having a second fiber accommodating hole as a hole extending along the first direction and communicating with the first fiber accommodating hole at the rear end of the ferrule; and
a plurality of optical fibers each having a glass fiber and a coating portion, the glass fiber including a first diameter portion, a second diameter portion having a larger diameter than a diameter of the first diameter portion, and a tapered portion connecting the first diameter portion and the second diameter portion, at least the first diameter portion, the tapered portion, and the second diameter portion extending along the first direction, and the coating portion being formed by covering a glass fiber continuous with the second diameter portion with a coating, wherein
the first diameter portion of each of the plurality of optical fibers is inserted into the first portion of the first fiber accommodating hole,
the tapered portion of each of the plurality of optical fibers is inserted into the second portion of the first fiber accommodating hole,
a boundary between the second diameter portion of each of the plurality of optical fibers and the coating portion of each of the plurality of optical fibers is inserted into the second fiber accommodating hole,
the plurality of optical fibers are fixed to the ferrule with an adhesive,
the coating of each of the plurality of optical fibers includes a different appearance for each optical fiber and is fixed to the coating of at least one optical fiber of the plurality of optical fibers,
the coating of each of the plurality of optical fibers includes a tip portion adjacent to the second diameter portion and a terminal end portion opposite to the tip portion, and
the optical fiber bundle having at least one configuration of a first configuration and a second configuration, the first configuration is a configuration in which the first diameter portion of one optical fiber of the plurality of optical fibers has no crossing with first diameter portions within the ferrule, each of the first diameter portions being the first diameter portion of an other optical fiber of the plurality of optical fibers, and the second configuration is a configuration in which an arrangement of the plurality of optical fibers at the front end of the ferrule has no deviation with an arrangement of the plurality of optical fibers at the second fiber accommodating hole along a circumferential direction around a central axis of the first fiber accommodating hole and the second fiber accommodating hole, or has the deviation of less than 90 degrees.

7. The optical fiber bundle according to claim 6, wherein in each of the plurality of optical fibers, an appearance of the tip portion of the coating and an appearance of the terminal end portion of the coating include colors or hues corresponding to each other.

8. The optical fiber bundle according to claim 6, wherein an appearance of the coating of each of the plurality of optical fibers includes a different color or hue for each optical fiber.

9. The optical fiber bundle according to claim 6, wherein an appearance of the coating of each of the plurality of optical fibers includes a different marking for each optical fiber.

10. The optical fiber bundle according to claim 6, wherein the coating of each of the plurality of optical fibers has a different outer diameter for each optical fiber.

11. The optical fiber bundle according to claim 6, wherein the coating of each of the plurality of optical fibers includes a different material for each optical fiber.

12. The optical fiber bundle according to claim 6, wherein each of the plurality of optical fibers includes a first tape and a second tape having appearances corresponding to each other, the appearances of first tapes, each of the first tapes being the first tape of each of the plurality of optical fibers, are different from each other, and the appearances of second tapes, each of the second tapes being the second tape of each of the plurality of optical fibers, are different from each other, the tip portion of the coating is labeled with the first tape, and the terminal end portion of the coating is labeled with the second tape.

13. The optical fiber bundle according to claim 6, wherein at least a part of the plurality of optical fibers is formed into an optical fiber ribbon.

14. An optical connection structure comprising:
an optical connector including the optical fiber bundle according to claim 6;
another optical connector including a multi-core optical fiber and another ferrule, the multi-core optical fiber including a plurality of cores extending along a first direction and a cladding covering the plurality of cores, and the another ferrule holding a tip of the multi-core optical fiber, wherein
when the optical connector is connected to the another optical connector, each core of the plurality of optical fibers is optically coupled to the plurality of cores of the multi-core optical fiber.

15. A determination method for determining a state of a plurality of optical fibers in a ferrule when the plurality of optical fibers are inserted into a hole provided in the ferrule from a rear end of the ferrule, the determination method comprising:
confirming an arrangement of the plurality of optical fibers at a front end of the ferrule by conducting light from a terminal end surface of each of the plurality of optical fibers and observing a tip surface of each of the plurality of optical fibers, the tip surface being opposite to the terminal end surface;
determining whether one or both of crossing and deviation occur, the crossing being a crossing within the ferrule between one optical fiber of the plurality of optical fibers and other optical fibers of the plurality of optical fibers, and the deviation being a deviation between an arrangement of the plurality of optical fibers at a front end of the ferrule and an arrangement of the plurality of optical fibers at a rear end of the ferrule and being a deviation of a predetermined angle or more along a circumferential direction around a central axis of the hole of the ferrule.
